(19) United States
(12) Patent Application Publication
(10) Pub. No.: US 2004/0196574 A1
(43) Pub. Date: Oct. 7, 2004

(54) Image-formation optical system

(75) Inventors: Noriko Tanaka, Zama-shi (JP); Ayami Imamura, Tokyo (JP)

Correspondence Address: PILLSBURY WINTHROP, LLP, P.O. BOX 10500, MCLEAN, VA, 22102, US

(73) Assignee: Olympus Optical Co., Ltd., Tokyo (JP)

(21) Appl. No.: 10/403,508

(22) Filed: Apr. 1, 2003

(51) Int. Cl. H04N 1/034; G02B 9/34

(52) U.S. Cl. 359/779

(57) ABSTRACT

The invention relates to an image-formation lens system for reading images, etc., which has an image-formation magnification of less than 1×, comprises a reduced number of lenses, has a short length and compactness, and is fabricated with improved image quality yet at low cost. The image-formation lens system of the four-unit type comprises, in order from its object side toward its image side, a first lens L1 having positive power, a second lens L2 having positive power, a third lens L3 having negative lens and a fourth lens L4 having positive power. The image-formation lens system satisfies conditions (1) and (3) with respect to the Abbe numbers of L1 and L3 and conditions (2) and (4) with respect to the refractive indices of L2 and L4.

### BACKGROUND OF THE INVENTION

The present invention relates generally to an image-formation optical system, and more particularly to an image-formation lens system for reading images, which is incorporated for optical systems in image readers such as image scanners.

Among systems for forming input images on image pickup planes of image pickup devices such as CCDs, there is an image scanner. An image-formation lens system for reading images, which is used for such an image scanner, must possess the following optical properties:

(1) it must have high resolving power at the image-formation magnification used,

(2) the quality of ambient light must be large enough,

(3) distortion must be reduced, and

(4) it must be substantially telecentric on the image side.

Lens systems so far known to satisfy the above requirements includes a Gauss type lens system as represented by that set forth in JP-A 5-107472.

The present applicant, too, has come up with a lens system composed of four lenses in JP-A 9-222560. Albeit being composed of a reduced number of lenses, this lens system can provide an image-formation lens system for reading images, which has a short length and small size, is inexpensive and ensures that formed images are of enhanced image quality.

In recent years, image scanners or like processors have been required to ensure much wider reading areas. For image pickup devices such as CCDs, too, size reductions are needed to reduce the whole size of the lens system. In other words, there is still demand for an image-formation lens system that, while ensuring a wide reading area, enables an optical system to have an even lower image-formation magnification to make an image pickup device small.

### SUMMARY OF THE INVENTION

The present invention provides an image-formation lens system, comprising in order from an object side toward an image side thereof,

a first lens unit having positive power,

a second lens unit having positive power,

a third lens unit having negative power, and

a fourth lens unit having positive power, and satisfying the following conditions (1) to (4):

50<ν_{d1}<110 (1)

1.75<n_{d2}<2.1 (2)

10<ν_{d3}<30 (3)

1.75<n_{d4}<2.1 (4)

where ν_{d1} is the Abbe number on a d-line basis of the first lens unit, n_{d2} is the d-line refractive index of the second lens unit, ν_{d3} is the Abbe number on a d-line basis of the third lens unit, and n_{d4} is the d-line refractive index of the fourth lens unit.

The present invention also provides an image-formation lens system, comprising:

an aperture stop,

a lens unit located in front of the aperture stop and having generally positive power,

a lens unit located in rear of the aperture stop and having generally negative power,

a lens unit located in rear of the lens unit having negative power and having generally positive power, and

an electronic image pickup device located at a position of an image formed by the image-formation lens system, wherein:

the electronic image pickup device is a color line sensor comprising an array of photodetectors provided thereon with at least red (R), green (G) and blue (B) color filters in association therewith, and the image-formation lens system satisfies the following conditions (7) and (8):

0.12<|β|<0.60 (7)

7.1°<φ<20° (8)

where β is the magnification of the image-formation lens system, and φ is an angle made by two light rays at the position of an image formed by the image-formation lens system, wherein one of the two light rays is an off-axis chief ray passing through the position of a maximum image height and another is parallel with the optical axis of the image-formation lens system.

Further, the present invention provides an ink jet recorder system, comprising:

a carriage that reciprocates along an opposing recording medium, wherein:

the carriage comprises in combination:

an ink jet unit comprising a plurality of ink jet nozzles that jet ink to form an image on the opposing recording medium,

an image reader unit that optically reads the image formed on the opposing recording medium during movement of the carriage,

a lighting unit for lighting an area in which the image is read by the image reader unit, and

an image-formation lens system as recited in claim 1 or 11, which is mounted on the image reader unit.

Still other objects and advantages of the invention will be part be obvious and will in part be apparent from the specification.

The invention accordingly comprises the features of construction, combinations of elements, and arrangement of parts, which will be exemplified in the construction hereinafter set forth, and the scope of the invention will be indicated in the claims.

### BRIEF DESCRIPTION OF THE DRAWINGS

FIG. 1 is illustrative in section of Example 1 of the image-formation lens system according to the invention.

FIG. 2 is illustrative in section of Example 2 of the image-formation lens system according to the invention.

FIG. 3 is illustrative in section of Example 3 of the image-formation lens system according to the invention.

FIG. 4 is illustrative in section of Example 4 of the image-formation lens system according to the invention.

FIG. 5 is illustrative in section of Example 5 of the image-formation lens system according to the invention.

FIG. 6 is illustrative in section of Example 6 of the image-formation lens system according to the invention.

FIG. 7 is illustrative in section of Example 7 of the image-formation lens system according to the invention.

FIG. 8 is illustrative in section of Example 8 of the image-formation lens system according to the invention.

FIG. 9 is diagrammatically illustrative of aberrations of Example 1.

FIGS. 10(a) and 10(b) are illustrative of how an optical element for bending an optical path is interposed in the image-formation lens system of the invention.

FIG. 11 is illustrative of the appearance of one embodiment of the ink jet recorder of the invention.

FIG. 12 is illustrative of one specific construction of an image printer system using the ink jet recorder of FIG. 11.

FIGS. 13(A), 13(B) and 13(C) are illustrative in schematic of main parts of the ink jet recorder of FIG. 11.

FIG. 14 is illustrative of image reader means and lighting means in the ink jet recorder of the FIG. 11.

FIG. 15 is a front perspective view of the appearance of a digital camera in which the image-formation lens system of the invention is built.

FIG. 16 is a rear perspective view of the digital camera of FIG. 15.

FIG. 17 is a sectional view of the digital camera of FIG. 15.

FIG. 18 is a front perspective view of an uncovered personal computer in which the image-formation lens system of the invention is built as an objective optical system.

FIG. 19 is a sectional view of a phototaking optical system in the personal computer.

FIG. 20 is a side view of FIG. 18.

FIGS. 21(a) and 21(b) are a front and a side view of a cellular phone in which the image-formation lens system of the invention is incorporated as an objective lens system, and FIG. 21(c) is a sectional view of a photo-taking optical system therein.

### DESCRIPTION OF THE PREFERRED EMBODIMENTS

The reasons for using the aforesaid arrangements, and the advantages of them are now explained.

Each of the 1st to 4th lens units is explained on the assumption that it is composed of one single lens. However, it is understood that each lens unit is not necessarily required to consist of a single lens; it could be composed of a doublet or a plurality of lenses.

In the present invention, the image-formation lens system is made up of, in order from its object side, a first lens having positive power, a second lens having positive power, a third lens having negative power and a fourth lens having positive power, four lens units in all.

In this case, the lens system should be of a substantially telecentric type on the image side, so that images can be read by electronic image pickup devices such as CCDs. Preferably to this end, the positive lens having strong power should be located nearest to the image side. To diminish the Petzval's sum and keep field curvature small, this positive lens should preferably have a high refractive index or satisfy the following condition (4).

1.75<n_{d4}<2.1 (4)

Here n_{d4} is the d-line refractive index of the fourth lens.

As the lower limit of 1.75 to condition (4) is not reached, field curvature becomes large. As the upper limit of 2.1 is exceeded, there is little or no available vitreous material, and it is impossible to make full correction for chromatic aberrations because of extremely increased dispersion.

To correct the image-formation lens system for field curvature produced at the positive lens of strong power located nearest to the image side, the negative lens should preferably be located on the object side of this positive lens. To make correction for chromatic aberrations produced at the positive lens, this negative lens should preferably satisfy the following condition (3):

10<ν_{d3}<30 (3)

Here ν_{d3} is the Abbe number on a d-line basis of the third lens.

As the upper limit of 30 to condition (3) is exceeded, it is impossible to make full correction for chromatic aberrations. As the lower limit of 10 is not reached, there is little or no available vitreous material; it is impossible to make the best selection from existing vitreous materials. More preferably, condition (3) should be narrowed down as below.

20<ν_{d3}<30 (3-1)

To make short the length of the optical system, the general power of the lens system should be increased. To make satisfactory correction for aberrations from the center to the periphery of the optical system, on the other hand, it is desired that an efficient power profile be imparted to the optical system in such a way that light rays pass smoothly through the optical system. To that end, both the first lens and the second lens should preferably have positive power.

Chromatic aberrations are likely to occur at the positive lens located nearest to the object side, because the ray height of a light beam toward each image height is large. To reduce chromatic aberrations as much as possible, it is preferable to satisfy the following condition (1):

50<ν_{d1}<110 (1)

Here ν_{d1} is the Abbe number on a d-line basis of the first lens.

As the lower limit of 50 to condition (1) is not reached, it is impossible to make full correction for chromatic aberrations produced at the positive lens with the negative lens that is the third lens. As the upper limit of 110 is exceeded, there is no longer any vitreous material having a high refractive index, and the Petzval's sum becomes large, leading to increased field curvature. More preferably, the range of condition (1) should be narrowed down as follows.

50<ν_{d1}<96 (1-1)

To diminish the Petzval's sum and keep field curvature low, the second positive lens as counted from the object side should preferably satisfy the following condition (2):

1.75<n_{d2}<2.1 (2)

Here n_{d2} is the d-line refractive index of the second lens.

As the lower limit of 1.75 to condition (2) is not reached, it is impossible to keep field curvature low. As the upper limit of 2.1 is exceeded, there is little or no available vitreous material, and chromatic aberrations cannot be well corrected because of extremely increased dispersion.

The brightness of the image-formation lens system according to the present invention is determined by a stop located therein. When the stop is located in front of the lens system, the size of the lens unit on the image side becomes large, resulting in an increase in the whole size of the lens system. When the stop is located in the rear of the lens system, it is difficult to achieve an optical system that is of the telecentric type on the image side. It is particularly preferable that the stop is located in an optical path between the second lens and the fourth lens, e.g., between the second lens and the third lens.

The image-formation optical system of the present invention, as explained above, should preferably satisfy the following condition (5):

0.1<D/f<0.6 (5)

Here D is the axial space between the third lens and the fourth lens, and f is the focal length of the image-formation lens system.

As already explained, the positive lens of strong power is used for the fourth lens, so that the image-formation lens system of the invention is set up in the form of an optical system that is substantially telecentric on the image side. The nearer to the image plane the fourth lens, the better the telecentric capability becomes; however, the fourth lens contributes less to imaging and so aberrations cannot be corrected. Conversely, as the fourth lens comes closer to the object side, it is more difficult to ensure the telecentric capability; however, the fourth lens contributes more to correction of aberrations.

To reconcile the telecentric capability on the image side with correction of aberrations, the image-formation lens system of the present invention should preferably satisfy condition (5).

As the lower limit of 0.1 to condition (5) is not reached, the space between the third lens and the fourth lens becomes too short relative to the focal length of the image-formation lens system and, hence, the fourth lens is far away from the image plane, resulting in a failure to ensure any telecentric capability. As the upper limit of 0.6 is exceeded, the third lens is too far away from the fourth lens, ending up with an increase in the length and size of the optical system. More preferably, the image-formation lens system of the present invention should satisfy condition (5-1).

0.2<D/f<0.4 (5-1)

Satisfaction of condition (5-1) enables the aberration performance of the optical system to be improved while the telecentric capability is ensured.

Then, the magnification of the image-formation lens system according to the present invention is explained. To make the extent of reading area and reduce the size of an image pickup device, the magnification of the lens system should be less than 1×.

0.12<|β|<0.60 (7)

Here β is the reduction ratio of the optical system (the image-formation lens system) from the first lens to the fourth lens.

As the lower limit of 0.12 to condition (7) is not reached, it is difficult to keep the length of the optical system short and reduce aberrations satisfactorily as well. As the upper limit of 0.60 is exceeded, the extent of reading cannot be widened without increasing the size of the image pickup device. When a small image pickup device is used, it is impossible to ensure the wide extent of reading.

More preferably, the range of condition (7) should be narrowed down to condition (7-1).

0.13<|β|<0.55 (7-1)

Most preferably,

0.14<|β|<0.50 (7-2)

To add to this, the image-formation lens system of the present invention should satisfy the following condition (6):

1.5<f_{F}/f_{R}<4.0 (6)

Here f_{F} is the composite focal length from the first lens to the third lens, and f_{R} is the focal length of the fourth lens.

Suppose now that the first, the second and the third lens form a front unit and the fourth lens forms a rear unit. As the focal length of the front unit is equal to that of the rear unit, it is possible to reduce distortion in particular. The optical system is then a 1× image-formation optical system. However, the optical system of the present invention is never a 1× image-formation lens system because the object of the present invention is to reduce the size of the image pickup device while the area of reading is widened. To make satisfactory correction for distortion irrespective of 1× image formation, it is desirable to satisfy condition (6).

As the lower limit of 1.5 to condition (6) is not reached, the power of the fourth lens becomes weak, failing to make the optical system telecentric on the image side. As the upper limit of 4.0 is exceeded, it is difficult to reduce distortion and coma. More desirously, condition (6-1) should be satisfied.

1.8<f_{F}/f_{R}<3.3 (6)

Satisfaction of condition (6-1) enables distortion and coma to be much more reduced while the telecentric capability of the optical system on the image side is much more enhanced.

Next, the range of the angle of incidence φ of an off-axis chief ray on the image pickup device is considered. When a CCD having a microlens is used for the image pickup device, the optical system must be substantially telecentric on the image side. The off-axis chief ray is apt to be obliquely incident on the plane of the image pickup device. Such oblique incidence must be avoided as much as possible, because of incurring a light quantity drop (shading).

To make the optical system telecentric on image side, the lens of strong positive power must be located nearest to the image side to provide a strong bending of the ray. However, the strong bending of the ray could often lead to aberrations.

With a CCD having a microlens located at the optimized position to address the oblique incidence of the off-axis chief ray or a CCD having no microlens, it is acceptable that the off-axis chief ray is incident on the image pickup plane at a certain angle. It is then possible to weaken the power of the positive lens located nearest to the image side, thereby reducing aberrations.

In any case, it is preferable to satisfy the following condition (8):

7.1°<φ<20° (8)

Here φ is the angle that an off-axis chief ray passing through the first lens to the fourth lens to form an image at the farthest image end makes with the normal to the image pickup plane of the electronic image pickup device. In another parlance, φ is the angle made by two light rays at the position of an image formed by the image-formation lens system, one of which is given by the off-axis chief ray passing through the position of the maximum image height and another is given by a light ray parallel with the optical axis of the image-formation lens system.

As the angle φ that the off-axis chief ray makes with the normal to the image pickup plane is less than the lower limit of 7.1° to condition (8), it is difficult to reduce aberrations. Forced reductions of aberrations cause the number of lenses in the optical system to increase or the length of the optical system to become overly long. As the upper limit of 20° is exceeded, the quantity of ambient light drops.

More preferably, the range of condition (8) should be narrowed down as in the following condition (8-1).

7.5°<φ<18° (8-1)

Even more preferably,

8.0°<φ<15° (8-2)

Most preferably,

9.0°<φ<13° (8-3)

It is here noted that for the image-formation lens system of the present invention comprising, in order from its object side, the first lens of positive power, the second lens of positive power, the third lens of negative power and the fourth lens of positive power, four lens units in all, it could be acceptable to locate an optical element for bending an optical path between the first lens and the object or between the fourth lens and the image.

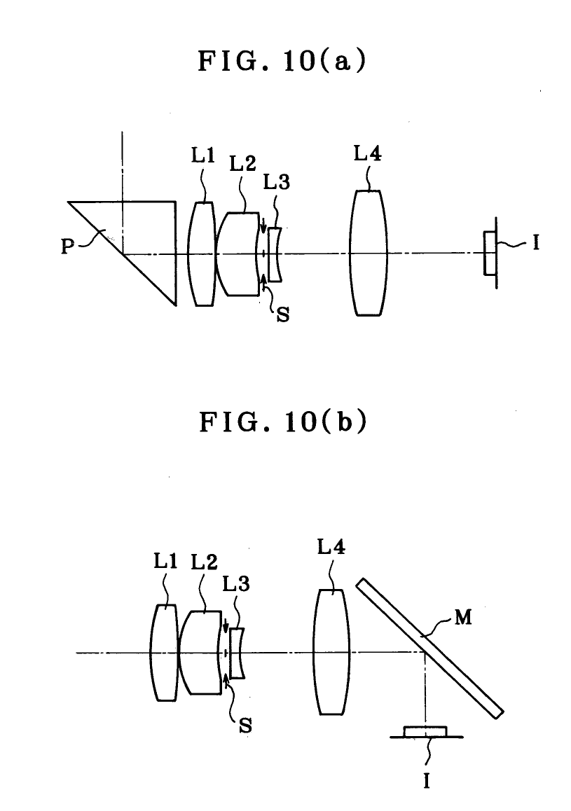

When there is provided no optical path-bending optical element, the size of the optical system is determined by the length from the object to the image in an optical axis direction and the diameters of lenses in a direction vertical to the optical axis. With the optical path-bending optical element, for instance, an optical path-bending prism P for bending an optical path through 45° as shown in FIG. 10(a) located between the first lens L1 and the object, the direction vertical to the optical axis direction along which the lenses L1 to L4 in the lens system and the stop S are arranged may be phototaken. Referring here to the size of the optical system, the size of the optical system in the phototaking direction is defined by the size from the object to the bent portion of the optical path while the size of the optical system in the optical axis direction is defined by the size of the optical system from the bent portion of the optical path to the image pickup plane I. Thus, the thickness of the optical system in the phototaking direction is determined by the length of the optical system from the object to the bent portion of the optical path rather than by the length from the object to the image, so that the thickness of the optical system in the phototaking direction can be reduced; that is, the optical system can be slimmed down in the phototaking direction.

The same also holds true when the optical path-bending optical element, for instance, a mirror A for bending an optical path through 45° as shown in FIG. 10(b) is located between the fourth lens L4 and the image pickup plane I.

For the image-formation lens system of the present invention, it is noted that both surfaces of at least one lens could be defined by convex or concave surfaces having an equal radius of curvature, so that the optical system could be easy to fabricate and assemble because the same performance could be maintainable when that lens is turned top side down.

It is understood that a two-dimensional or one-dimensional image pickup device such as a CCD may be used for the electronic image pickup device located on the image plane of the image-formation lens system of the present invention. The one-dimensional image pickup device, also referred to as a line sensor, includes a color line sensor in which three lines of photodetectors are arrayed parallel with one another in a proximate fashion, with red (R), green (G) and blue (B) color filters located on the image pickup planes on the respective lines. The photodetectors are relatively scanned in a direction orthogonal to each photodetector line so that color separation signals for R, G and B are obtainable.

For instance, when the image-formation lens system of the present invention is used to read images, it is preferable for size reductions that while the object of the lens system remains fixed in position, the distance from the object to the image plane formed by the lens system is set at 200 mm or less.

Specifically but not exclusively, the image-formation lens system of the present invention may be used with an image pickup system for imaging systems, image reading means for ink jet recorders, etc.

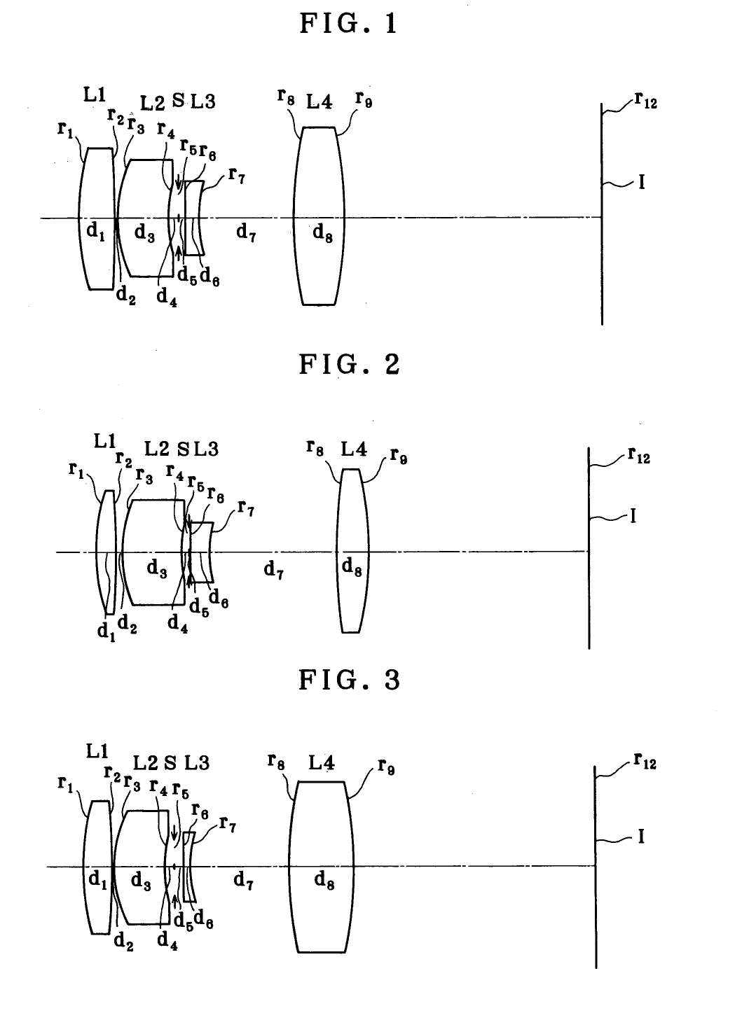

Examples 1-8 of the image-formation lens system of the present invention are now given below. FIGS. 1-8 are illustrative in section of Examples 1-8. In FIGS. 1-8, L1 represents a first lens, L2 a second lens, L3 a third lens, L4 a fourth lens, S a stop, and I an image plane. While plane parallel plates such as filters located on the image plane side are not shown, it is understood that data on such plates are enumerated in the numerical data given later.

### EXAMPLE 1

As shown in FIG. 1, this example is directed to a four-unit, four-lens image-formation lens system consisting of, in order from its object side, a double-convex positive lens L1, a positive meniscus lens L2 convex on its object side, a stop S, a negative meniscus lens L3 convex on its object side and a double-convex positive lens L4. Both surfaces of the fourth lens L4 have an equal radius-of-curvature absolute value.

### EXAMPLE 2

As shown in FIG. 2, this example is directed to a four-unit, four-lens image-formation lens system consisting of, in order from its object side, a double-convex positive lens L1, a positive meniscus lens L2 convex on its object side, a stop S, a double-concave negative lens L3 and a double-convex positive lens L4.

### EXAMPLE 3

As shown in FIG. 3, this example is directed to a four-unit, four-lens image-formation lens system consisting of, in order from its object side, a double-convex positive lens L1, a positive meniscus lens L2 convex on its object side, a stop S, a negative meniscus lens L3 convex on its object side and a double-convex positive lens L4. Both surfaces of the fourth lens L4 have an equal radius-of-curvature absolute value.

### EXAMPLE 4

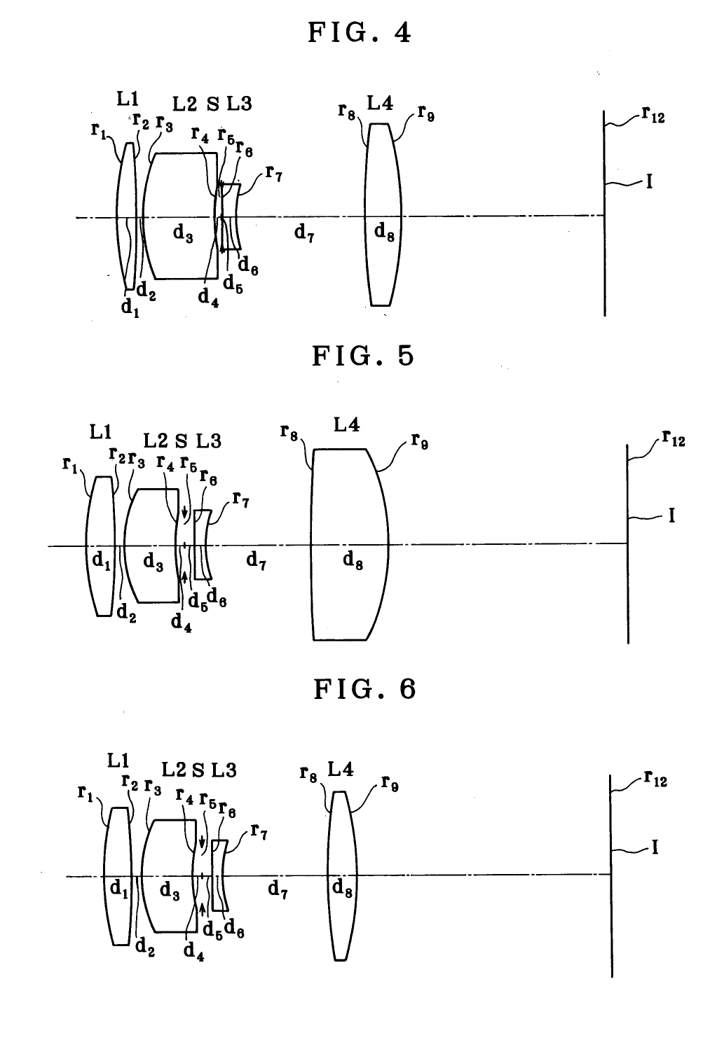

As shown in FIG. 4, this example is directed to a four-unit, four-lens image-formation lens system consisting of, in order from its object side, a double-convex positive lens L1, a positive meniscus lens L2 convex on its object side, a stop S, a double-concave negative lens L3 and a double-convex positive lens L4.

### EXAMPLE 5

As shown in FIG. 5, this example is directed to a four-unit, four-lens image-formation lens system consisting of, in order from its object side, a double-convex positive lens L1, a positive meniscus lens L2 convex on its object side, a stop S, a plano-concave negative lens L3 and a double-convex positive lens L4.

### EXAMPLE 6

As shown in FIG. 6, this example is directed to a four-unit, four-lens image-formation lens system consisting of, in order from its object side, a double-convex positive lens L1, a positive meniscus lens L2 convex on its object side, a stop S, a plano-concave negative lens L3 and a double-convex positive lens L4.

### EXAMPLE 7

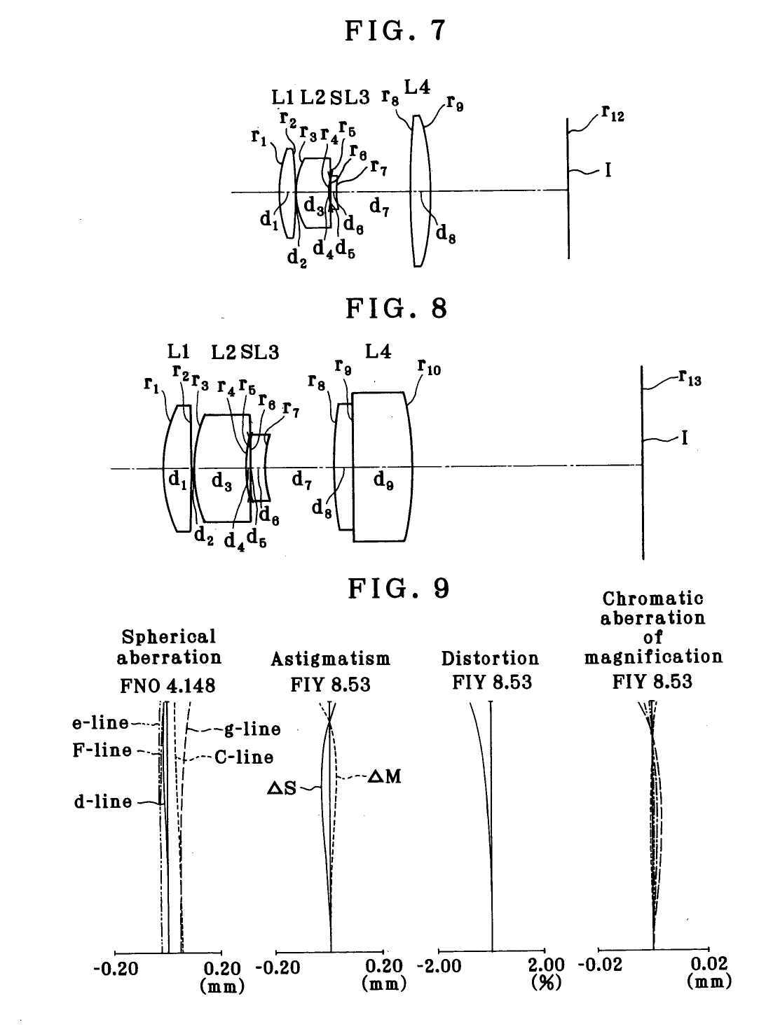

As shown in FIG. 7, this example is directed to a four-unit, four-lens image-formation lens system consisting of, in order from its object side, a double-convex positive lens L1, a positive meniscus lens L2 convex on its object side, a stop S, a negative meniscus lens L3 convex on its object side and a double-convex positive lens L4.

### EXAMPLE 8

As shown in FIG. 8, this example is directed to a four-unit, five-lens image-formation lens system consisting of, in order from its object side, a double-convex positive lens L1, a positive meniscus lens L2 convex on its object side, a stop S, a double-concave negative lens L3 and a doublet L4 consisting of a double-convex positive lens and a positive meniscus lens convex on its image plane side.

Numerical data on the respective examples are given below. For the symbols used hereinafter but not in hereinbefore,

f: focal length of the image-formation lens system,

β: magnification,

2ω: angle of view,

IO: distance from the object plane to the image plane,

r₁, r₂, . . . : radius of curvature of each lens surface,

d₁, d₂, . . . : separation between adjacent lens surfaces,

n_{d1}, n_{d2}, . . . : d-line refractive index of each lens, and

ν_{d1}, ν_{d2}, . . . : Abbe number of each lens.

### EXAMPLE 1

f = 28.40 mm
β = −0.31
2ω = 23.8°
I O = 151 mm

| | | | |
|---|---|---|---|
| r₀ = ∞(Object plane) | d₀ = 110.1052 | | |
| r₁ = 20.1136 | d₁ = 2.9000 | n_{d1} = 1.69680 | ν_{d1} = 55.53 |
| r₂ = −104.4311 | d₂ = 0.1500 | | |
| r₃ = 10.3356 | d₃ = 4.0755 | n_{d2} = 1.77250 | ν_{d2} = 49.60 |
| r₄ = 12.1520 | d₄ = 0.8000 | | |
| r₅ = ∞(Stop) | d₅ = 0.5000 | | |
| r₆ = 213.3075 | d₆ = 1.0000 | n_{d3} = 1.84666 | ν_{d3} = 23.78 |
| r₇ = 8.6407 | d₇ = 7.5622 | | |
| r₈ = 32.0375 | d₈ = 4.0000 | n_{d4} = 1.77250 | ν_{d4} = 49.60 |
| r₉ = −32.0375 | d₉ = 1.0000 | | |
| r₁₀ = ∞ | d₁₀ = 0.7000 | n_{d5} = 1.48749 | ν_{d5} = 70.23 |
| r₁₁ = ∞ | d₁₁ = 18.1733 | | |
| r₁₂ = ∞(Image plane) | | | |

### EXAMPLE 2

f = 29.11 mm
β = −0.32
2ω = 23.1°
I O = 148.9 mm

| | | | |
|---|---|---|---|
| r₀ = ∞(Object plane) | d₀ = 110.1052 | | |
| r₁ = 16.3628 | d₁ = 1.6497 | n_{d1} = 1.69680 | ν_{d1} = 55.53 |
| r₂ = −102.7513 | d₂ = 0.5356 | | |
| r₃ = 11.7931 | d₃ = 4.7027 | n_{d2} = 1.77250 | ν_{d2} = 49.60 |
| r₄ = 15.6722 | d₄ = 0.6056 | | |
| r₅ = ∞(Stop) | d₅ = 0.1055 | | |
| r₆ = −239.4490 | d₆ = 1.4803 | n_{d3} = 1.84666 | ν_{d3} = 23.78 |
| r₇ = 8.1400 | d₇ = 10.0529 | | |
| r₈ = 43.3538 | d₈ = 2.5603 | n_{d4} = 1.77250 | ν_{d4} = 49.60 |
| r₉ = −29.3711 | d₉ = 1.0000 | | |
| r₁₀ = ∞ | d₁₀ = 0.8000 | n_{d5} = 1.48749 | ν_{d5} = 70.23 |
| r₁₁ = ∞ | d₁₁ = 15.3035 | | |
| r₁₂ = ∞(Image plane) | | | |

### EXAMPLE 3

f = 28.24 mm
β = −0.31
2ω = 24.2°
I O = 150.4 mm

| | | | |
|---|---|---|---|
| r₀ = ∞(Object plane) | d₀ = 110.1052 | | |
| r₁ = 21.7504 | d₁ = 2.2782 | n_{d1} = 1.65160 | ν_{d1} = 58.55 |
| r₂ = −66.6915 | d₂ = 0.1500 | | |
| r₃ = 9.7847 | d₃ = 4.7055 | n_{d2} = 1.77250 | ν_{d2} = 49.60 |
| r₄ = 12.0691 | d₄ = 0.8000 | | |
| r₅ = ∞(Stop) | d₅ = 0.7000 | | |
| r₆ = 117.0691 | d₆ = 0.5000 | n_{d3} = 1.84666 | ν_{d3} = 23.78 |
| r₇ = 8.2997 | d₇ = 7.9315 | | |
| r₈ = 32.9236 | d₈ = 5.0233 | n_{d4} = 1.77250 | ν_{d4} = 49.60 |
| r₉ = −32.9236 | d₉ = 1.0000 | | |
| r₁₀ = ∞ | d₁₀ = 0.7000 | n_{d5} = 1.48749 | ν_{d5} = 70.23 |
| r₁₁ = ∞ | d₁₁ = 17.1492 | | |
| r₁₂ = ∞(Image plane) | | | |

### EXAMPLE 4

f = 28.79 mm
β = −0.31
2ω = 23.4°
I O = 148.3 mm

| | | | |
|---|---|---|---|
| r₀ = ∞(Object plane) | d₀ = 110.1052 | | |
| r₁ = 17.0087 | d₁ = 1.5365 | n_{d1} = 1.65160 | ν_{d1} = 58.55 |
| r₂ = −101.7641 | d₂ = 0.5410 | | |
| r₃ = 12.1052 | d₃ = 5.8137 | n_{d2} = 1.77250 | ν_{d2} = 49.60 |
| r₄ = 17.3903 | d₄ = 0.4708 | | |
| r₅ = ∞(Stop) | d₅ = 0.0999 | | |
| r₆ = −547.5876 | d₆ = 1.0836 | n_{d3} = 1.84666 | ν_{d3} = 23.78 |
| r₇ = 8.0150 | d₇ = 9.9590 | | |
| r₈ = 39.0451 | d₈ = 2.9697 | n_{d4} = 1.77250 | ν_{d4} = 49.60 |
| r₉ = −29.7770 | d₉ = 1.0000 | | |
| r₁₀ = ∞ | d₁₀ = 0.8000 | n_{d5} = 1.48749 | ν_{d5} = 70.23 |
| r₁₁ = ∞ | d₁₁ = 13.9376 | | |
| r₁₂ = ∞(Image plane) | | | |

### EXAMPLE 5

f = 30.22 mm
β = −0.32
2ω = 23.0°
I O = 152.5 mm

| | | | |
|---|---|---|---|
| r₀ = ∞(Object plane) | d₀ = 110.1052 | | |
| r₁ = 20.3141 | d₁ = 2.2782 | n_{d1} = 1.65160 | ν_{d1} = 58.55 |
| r₂ = −58.1713 | d₂ = 0.7000 | | |
| r₃ = 10.2957 | d₃ = 4.0755 | n_{d2} = 1.77250 | ν_{d2} = 49.60 |
| r₄ = 13.7764 | d₄ = 0.8000 | | |
| r₅ = ∞(Stop) | d₅ = 0.8000 | | |
| r₆ = ∞ | d₆ = 0.8000 | n_{d3} = 1.84666 | ν_{d3} = 23.78 |
| r₇ = 7.7857 | d₇ = 8.3994 | | |
| r₈ = 149.5878 | d₈ = 6.1110 | n_{d4} = 1.77250 | ν_{d4} = 49.60 |
| r₉ = −17.7527 | d₉ = 1.0000 | | |
| r₁₀ = ∞ | d₁₀ = 0.8000 | n_{d5} = 1.48749 | ν_{d5} = 70.23 |
| r₁₁ = ∞ | d₁₁ = 16.6786 | | |
| r₁₂ = ∞(Image plane) | | | |

### EXAMPLE 6

f = 28.57 mm
β = −0.31
2ω = 23.9°
I O = 150 mm

| | | | |
|---|---|---|---|
| r₀ = ∞(Object plane) | d₀ = 110.1052 | | |
| r₁ = 22.9643 | d₁ = 2.2782 | n_{d1} = 1.65160 | ν_{d1} = 58.55 |
| r₂ = −57.0702 | d₂ = 0.7000 | | |
| r₃ = 10.0057 | d₃ = 4.0755 | n_{d2} = 1.77250 | ν_{d2} = 49.60 |
| r₄ = 12.2866 | d₄ = 0.8000 | | |
| r₅ = ∞(Stop) | d₅ = 0.8000 | | |
| r₆ = ∞ | d₆ = 0.8000 | n_{d3} = 1.84666 | ν_{d3} = 23.78 |
| r₇ = 8.5911 | d₇ = 8.3166 | | |
| r₈ = 40.6017 | d₈ = 2.3230 | n_{d4} = 1.77250 | ν_{d4} = 49.60 |
| r₉ = −25.3305 | d₉ = 1.0000 | | |
| r₁₀ = ∞ | d₁₀ = 0.7000 | n_{d5} = 1.48749 | ν_{d5} = 70.23 |
| r₁₁ = ∞ | d₁₁ = 18.0644 | | |
| r₁₂ = ∞(Image plane) | | | |

### EXAMPLE 7

f = 36.96 mm
β = −0.56
2ω = 25.4°
I O = 155.5 mm

| | | | |
|---|---|---|---|
| r₀ = ∞(Object plane) | d₀ = 98.2762 | | |
| r₁ = 22.6284 | d₁ = 3.2256 | n_{d1} = 1.60300 | ν_{d1} = 65.44 |
| r₂ = −77.9082 | d₂ = 0.0356 | | |
| r₃ = 13.8969 | d₃ = 6.6229 | n_{d2} = 1.74400 | ν_{d2} = 44.78 |
| r₄ = 26.0984 | d₄ = 0.3060 | | |
| r₅ = ∞(Stop) | d₅ = 0.0092 | | |
| r₆ = 316.0445 | d₆ = 0.8947 | n_{d3} = 1.78472 | ν_{d3} = 25.68 |
| r₇ = 9.9097 | d₇ = 14.7295 | | |
| r₈ = 139.6653 | d₈ = 4.2265 | n_{d4} = 1.80610 | ν_{d4} = 40.92 |
| r₉ = −54.2956 | d₉ = 25.1239 | | |
| r₁₀ = ∞ | d₁₀ = 0.7000 | n_{d5} = 1.48749 | ν_{d5} = 70.23 |
| r₁₁ = ∞ | d₁₁ = 1.3346 | | |
| r₁₂ = ∞(Image plane) | | | |

### EXAMPLE 8

f = 26.75 mm
β = −0.31
2ω = 24.2°
I O = 1148.1 mm

| | | | |
|---|---|---|---|
| r₀ = ∞(Object plane) | d₀ = 110.1052 | | |
| r₁ = 13.4111 | d₁ = 2.1814 | n_{d1} = 1.69100 | ν_{d1} = 54.82 |
| r₂ = −175.3947 | d₂ = 0.2015 | | |
| r₃ = 11.7037 | d₃ = 4.2469 | n_{d2} = 1.77250 | ν_{d2} = 49.60 |
| r₄ = 14.8873 | d₄ = 0.2624 | | |
| r₅ = ∞(Stop) | d₅ = 0.0383 | | |
| r₆ = −97.1329 | d₆ = 1.1602 | n_{d3} = 1.80518 | ν_{d3} = 25.42 |
| r₇ = 7.8795 | d₇ = 5.5771 | | |
| r₈ = 41.5896 | d₈ = 1.3924 | n_{d4} = 1.80100 | ν_{d4} = 34.97 |
| r₉ = −7.4720.000 | d₉ = 4.7707 | n_{d5} = 1.71300 | ν_{d5} = 53.87 |
| r₁₀ = −28.1163 | d₁₀ = 14.3994 | | |
| r₁₁ = ∞ | d₁₁ = 0.7000 | n_{d6} = 1.48749 | ν_{d6} = 70.23 |
| r₁₂ = ∞ | d₁₂ = 3.0436 | | |
| r₁₃ = ∞(Image plane) | | | |

Aberration diagrams for Example 1 are given in FIG. 9 wherein “FIY” stands for an image height.

The values of the parameters concerning conditions (1) to (8) in Examples 1-8 are tabulated below.

| | Ex. | | | | | | | |
|---|---|---|---|---|---|---|---|---|
| | 1 | 2 | 3 | 4 | 5 | 6 | 7 | 8 |
| ν_{d1} | 55.53 | 55.53 | 58.55 | 58.55 | 58.55 | 58.55 | 65.44 | 54.82 |
| n_{d2} | 1.7725 | 1.7725 | 1.7725 | 1.7725 | 1.7725 | 1.7725 | 1.7440 | 1.7725 |
| ν_{d3} | 23.78 | 23.78 | 23.78 | 23.78 | 23.78 | 23.78 | 25.68 | 25.42 |
| n_{d4} | 1.7725 | 1.7725 | 1.7725 | 1.7725 | 1.7725 | 1.7725 | 1.8061 | 1.8010 |
| | | | | | | | | 1.7130 |
| D/f | 0.266 | 0.345 | 0.281 | 0.346 | 0.278 | 0.291 | 0.396 | 0.208 |
| f_{F}/f_{R} | 3.01 | 1.96 | 2.64 | 1.91 | 2.56 | 3.07 | 0.89 | 2.22 |
| \|β\| | 0.31 | 0.32 | 0.31 | 0.31 | 0.32 | 0.31 | 0.56 | 0.31 |
| φ (°) | 10.62 | 9.5 | 10.33 | 9.52 | 8.11 | 9.92 | 12.39 | 13.06 |

Throughout the examples, the stop S is located between the second lens L2 and the third lens L3; however, it could be positioned between the third lens L3 and the fourth lens L4.

Focusing on a nearby object point could be achieved by either movement of all the lenses along the optical axis or movement of the fourth lens L4 toward the object side.

While spherical surfaces are used for the lenses throughout the examples, it is understood that aspheric surfaces may be used. It is then preferable to use an aspheric surface for at least one surface of the fourth lens L4, because off-axis aberrations, especially distortion and astigmatism can be well corrected.

In all the above examples, if the object plane and the image plane are reversed in position, the image-formation lens system could then be used as a magnification optical system.

Either a line sensor or a two-dimensional image pickup device could be used as the electronic image pickup device located on the image plane I.

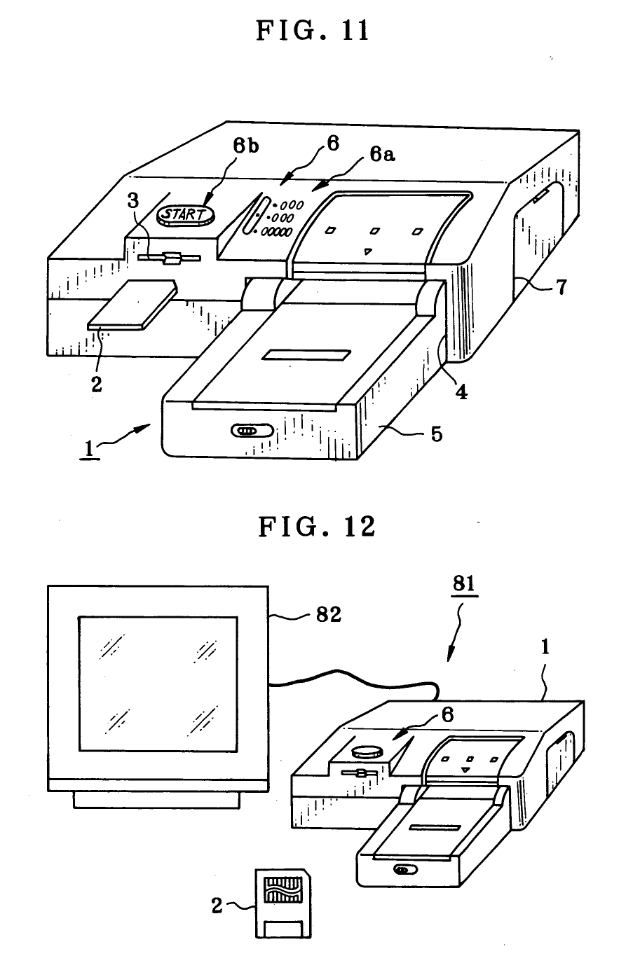

The image-formation lens system of the invention is now explained with reference to one embodiment of an ink jet recorder wherein it is used as image reading means. FIG. 11 is illustrative of the external configuration of one embodiment of the ink jet recorder according to the invention. In such an ink jet recorder as shown generally at 1, a smart media card 2 is so loaded that image data recorded therein can be read and printed.

The ink jet recorder 1 is provided at its front with a smart media card load port 3, adjacent to which there is positioned a paper feed cassette mount port 4. A paper feed cassette 5 is detachably attached to the paper feed paper cassette mount port 4.

The ink jet recorder 1 is provided on its upper surface with an operating unit 6 provided with a print mode selection button 6a, a print implementation (start) button 6b, etc.

The ink jet recorder 1 is provided on its one side with an inkbottle attachment port 7. For instance, six-color inkbottles for black ink, cyan ink, magenta ink, light cyan ink, light magenta ink and yellow ink are attached to that port 7. The ink jet recorder 1 is further provided on its back surface with a connector for connection to a monitor.

Using that ink jet recorder 1, such an image printer system 81 as shown in FIG. 12 is set up. This image printer system 81 is built up of the ink jet recorder 1, a small-sized recording medium detachably attached to the ink jet recorder 1 such as a smart media card 2 and a monitor 82 detachably attached to the ink jet recorder 1.

As the smart media card 2 is loaded into the ink jet recorder 1 in the image printer system 81 and the monitor 82 is connected to the connector, index images for image data stored in the smart media card 2 appear on the screen of the monitor 82 and, in response to this, the selection button or like on the operating unit 6 on the ink jet recorder 1 is operated to perform operation for designating the image to be printed out of the index images. Then, the print implementation button or the like is operated to print the designated image.

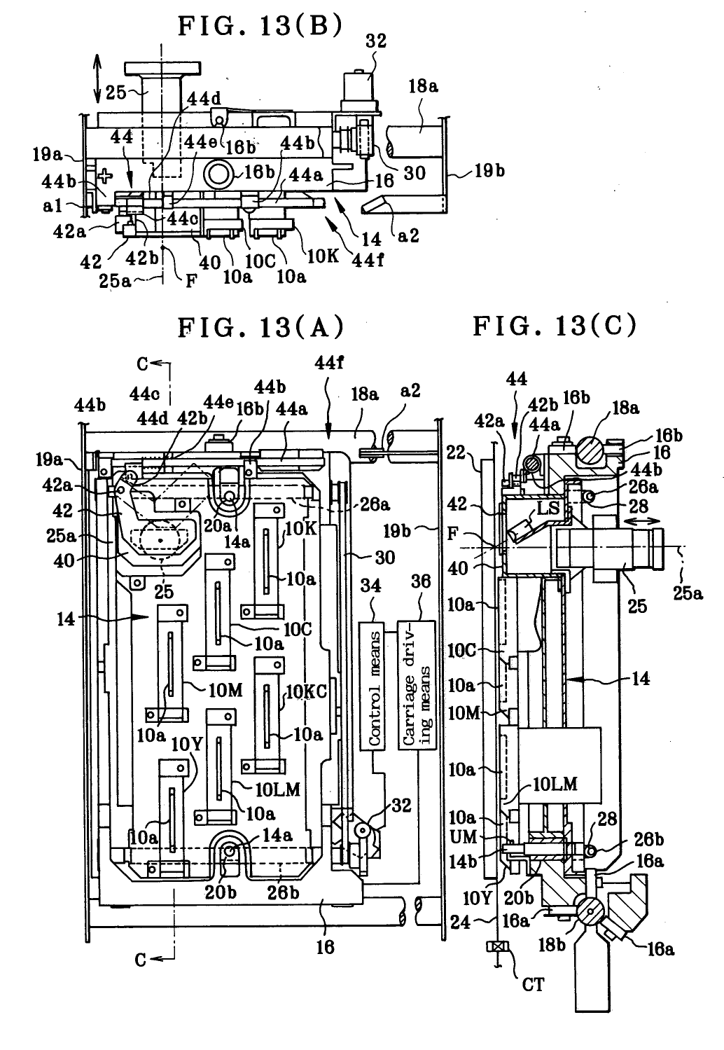

FIGS. 13(A), 13(B) and 13(C) are illustrative in schematic of main parts of the ink jet recorder 1 according to the above embodiment. FIG. 13(A) and FIG. 13(B) are a front and a plan view of the main parts, respectively, and FIG. 13(C) is a longitudinal section taken on line C-C of FIG. 13(A). More specifically, FIG. 13(C) is a longitudinal section for providing a clear illustration of image reading means and lighting means, showing the image reading means with its focus on a recording medium.

The main parts of the ink jet recorder according to the instant embodiment are now specifically explained.

This ink jet recorder is provided with six ink jet heads 10K, 10C, 10M, 10LC, 10LM and 10Y, each comprising a given array of ink jet nozzles 10a. The ink jet head 10K corresponds to black, 10C to cyan, 10M to magenta, 10LC to light cyan, 10LM to light magenta and 10Y to yellow. These ink jet heads 10K, 10C, 10M, 10LC, 10LM and 10Y are located on a head holder 14 in a given order. The inks of corresponding colors are fed to the ink jet heads from a main inkbottle mounted on a fixed frame (not shown) in the ink jet recorder for receiving black ink, cyan ink, magenta ink, light cyan ink, light magenta ink and yellow ink via a flexible ink feed tube (not shown) by means of an ink feed pump (not shown).

A carriage 16 is supported movably over a given range by a pair of guide rods 18a and 18b extending along a main scanning direction (in the horizontal direction in FIG. 13(A)).

Defined by a rectangular frame configuration, the carriage 16 is provided in its central space with a head holder 14 for holding six ink jet heads in place. The head holder 14 comprises a pair of upper and lower guide rods 14a and 14b that are inserted through a pair of thrust bearings 20a and 20b disposed on the upper and lower beams of the carriage 16. The pair of guide rods 14a and 14b extend in a direction (the vertical direction in FIG. 13(B)) that intersects the main scanning and direction and sub-scanning direction (the vertical direction in FIG. 13(B)), that is, in a direction that intersects the surface of the recording medium, so that the head holder 14 is guided and moved over the given range along the pair of thrust bearings 20a and 20b via the pair of guide rods 14a and 14b, so that the ink jet heads 10 can be moved toward or away from the recording medium.

The head holder 14 is further provided with optical image reading means 25 that is opposite to a recording medium 24 and a light source LS for directing light to the focus F of the image reading means 25.

The image reading means 25 is composed of a CCD. The image reading means 25 could be either a line senor or an area sensor.

The lighting means LS is composed of a linear array of small, power-saving laser diodes arranged in a direction parallel with the main scanning direction of the carriage 16. As can be seen from FIG. 13(C), the lighting means LS is positioned nearer to the recording medium 24 than to the image reading means 25.

Around the image reading means 25 and the lighting means LS, there is a cover housing 40 extending from the front of the head holder 14 toward the recording medium 24 in such a way as to provide a covering of the optical path around an optical axis 25a. The head holder 14 is rotatably provided with a shutter 42 for opening or closing an opening in an end projecting from the cover housing 40 while the carriage 16 is provided with a shutter opening/closing mechanism 44 for opening or closing the shutter 42.

The ink jet recorder further includes an ink jet head engagement/disengagement mechanism for engaging or disengaging the head holder 14 with or from the recording medium 24 over a given range. This ink jet head engagement/disengagement mechanism comprises bias means UM for biasing the head holder 14 away from the recording medium 24. The bias means UM is made up of compression springs wound around a pair of guide rods 14a and 14b between the pair of guide rods 14a and 14b of the head holder 14 and the pair of thrust bearings 20a and 20b of the carriage 16.

The ink jet head engagement/disengagement mechanism further comprises a pair of head holder drive rods 26a and 26b extending along the main scanning direction in the rear of the pair of guide rods 14a and 14b of the head holder 14, with both ends of each of the pair of head holder drive rods 26a and 26b rotatably supported at the carriage 16. The pair of head holder drive rods 26a and 26b are each fixedly provided with an eccentric cam 28, the periphery of which engages the rear surface of the head holder 14.

The pair of head holder drive rods 26a and 26b receive a timing belt 30 for rotating their respective eccentric cams 28 in synchronism with each other. The lower head holder drive rod 26b is connected with a pulse motor 32. The pulse motor 32 is rotated normally or oppositely to produce a drive force, which in turn causes normal or opposite synchronized rotation of the upper head holder drive rod 26a via the lower head holder drive rod 26b and the timing belt 30. Normal or opposite rotation of the pair of head holder drive rods 26a and 26b allows the eccentric cams 28 to move the head holder 14 toward the recording medium 24 against the bias force of the bias means UM or away from the recording medium 24 by means of the bias force of the bias means UM.

The pulse motor 32 is connected to control means 34, by which it is controlled. The control means 34 is further connected with known drive means (not shown) for 6 ink jet heads 10.

The carriage 16 is driven by known drive means 36 for reciprocation along the main scanning direction while it is supported at a pair of guide rods 18a and 18b.

In front of each ink jet head 10, there is located a flat platen 22 for supporting the recording medium 24. The platen 22 is provided on its surface with a number of suction holes (not shown), which are then connected to known negative pressure means (not shown), for instance, a suction fan. Thus, the recording medium 24 located on the surface of the platen 22 is brought into close contact with the surface of the platen 22 via a negative pressure generated out of a number of suction holes. However, this negative pressure should be low enough to have no adverse influence on the delivery of the recording medium 24 by recording medium delivery means.

Below the sub-scanning direction with respect to the platen 22 (downstream side of the delivery direction of the recording medium), there is provided cutting means CT for cutting the recording medium 24.

For brevity, the platen 22, the recording medium 24 thereon and the cutting means CT are shown in FIG. 13(C) only; they are not shown in FIGS. 13(A) and 13(B).

The recording medium 24 in this embodiment takes on a web form having a given width in the main scanning direction on the plate 22. This web could be formed of any desired material provided that ink droplets jetted out of the ink jet nozzle 10a can be deposited onto it. For instance, paper, cloth or plastic film could be used. Upon recording of images, the recording medium is delivered by known recording medium delivery means (not shown) over the platen 22 along the sub-scanning direction and intermittently at an interval and width in compliance with various recording modes.

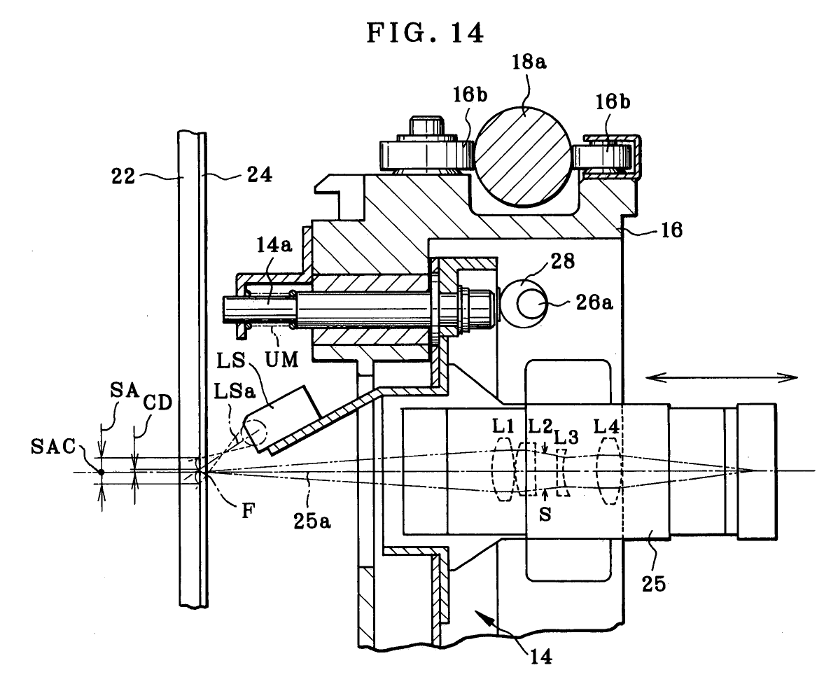

The image reading means 25 and lighting means LS are now explained in detail with reference to FIG. 14.

The lighting means LS is used to direct light to the range of the surface of the recording means 24 to be optically read by the image reading means 25.

The lighting means LS is positioned such that its point of light emission is displaced from the optical axis of 25a of the image reading means 25. Specifically, the lighting means LS is mounted on the head holder 14 such that when the focus F of the image reading means 25 is placed on the recording means 24, the center of the lighting means LS in the sub-scanning direction with respect to a lighting area on the recording medium 24 comes substantially in alignment with the optical axis 25a of the image reading means 25. More specifically, the lighting means LS is mounted on the head holder 14 while its optical axis LSa is inclined with respect to the optical axis 25a of the image reading means 25.

So far, small-sized, low-power-consumption type lighting means have preferentially been used, and so they must be inevitably of low output. To enhance the sensitivity upon reading of the image reading means 25, the optical axis 25a defining the center of the reading extent should preferably be in alignment with the optical axis LSa of the lighting means LS in the lighting range. For instance, one possible approach to this could be that the point of light emission of the lighting means LS is in line with the optical axis 25a of the image reading means 25 and the optical axis LSa of the lighting means LS is in line with the optical axis 25a of the image reading means 25. However, this approach is technically very difficult to achieve, and unfavorable in view of cost efficiency as well. Thus, it is preferable that while the point of light emission of the lighting means LS is displaced from the optical axis 25a of the image reading means 25, the optical axis LSa of the lighting means LS enters obliquely with respect to the optical axis 25a of the image reading means 25. For this reason, the optical axis 25a of the image reading means 25 is displaced from the center SAC of a lighting range SA by DC upward from the sub-scanning direction. Preferably in view of image reading, however, images should be read at a vertically and horizontally equal position in the lighting range. In the instant embodiment, therefore, the lighting means LS and image reading means 25 are mounted on the head holder 14 such that the optical axis 25a that defines the center of the extent to be read by the image reading means 25 is in alignment with the center of the lighting range in the sub-scanning direction.

Further, the lighting means LSc is mounted on the head holder 14 such that in the ink jet nozzles 10a out of six ink jet heads 10, a distance t1 between an ink jet nozzle 10a′ nearest to the center LSc of the lighting means LS and that center LSc is longer than a distance t2 between the ink jet nozzle 10a′ and the optical axis 25a of the image reading means 25.

Furthermore, the lighting means LS is mounted on the head holder 14 such that the distance between the lighting means LS and the cutting means CT is longer than that between the image reading means 25 and the cutting means CT.

The above arrangement is substantially similar to that set forth in JP-A 11-321029 (Japanese Patent Application No. 10-127722); for further details, see that publication.

In the ink jet recorder of such construction, the image-formation lens system of the invention, for instance, that of Example 1 comprising four lenses L1 to L4 is incorporated in the image reading means 25 in coaxial relation to its optical axis 25a, so that during movement of the carriage 16, images can be recorded on the opposing recording medium 24 by the ink jet heads 10K, 10C, 10M, 10LC, 10LM and 10Y. The images are then so reduced that they can be formed and read by the image-formation lens system on the CCD located on its image plane. In this way, the recorded images are estimated or otherwise utilized.

The present image-formation lens system constructed as described above may be applied to phototaking systems wherein images of distant objects are formed and then received on image pickup devices such as CCDs or silver-halide films, inter alia, digital cameras or video cameras as well as PCs and telephone sets that are typical information processors, in particular, easy-to-carry cellular phones. Given below are some such embodiments.

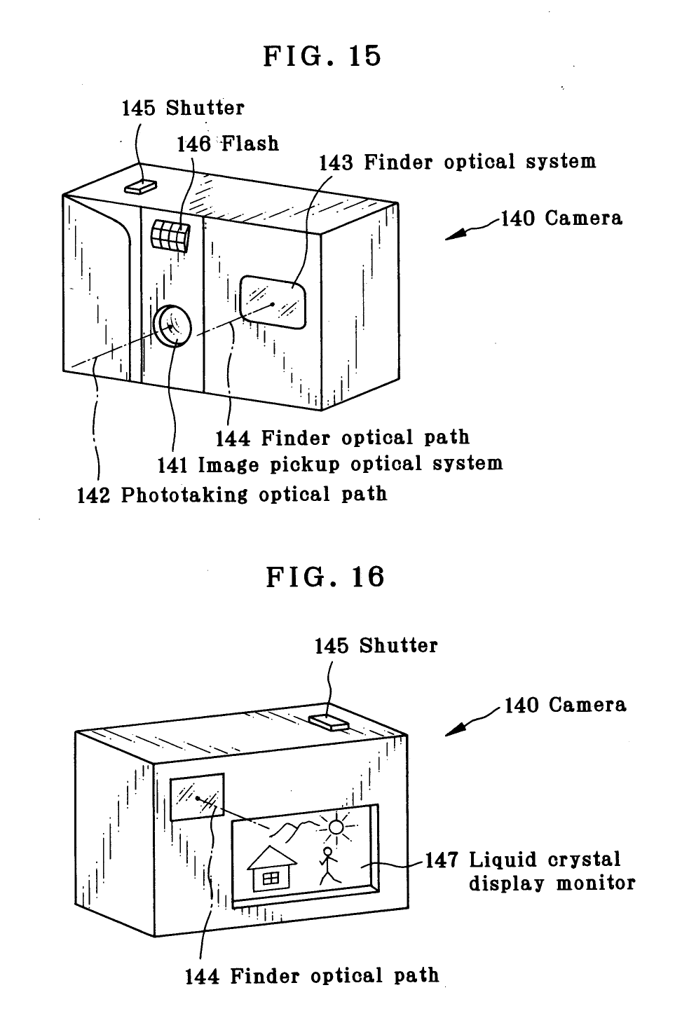

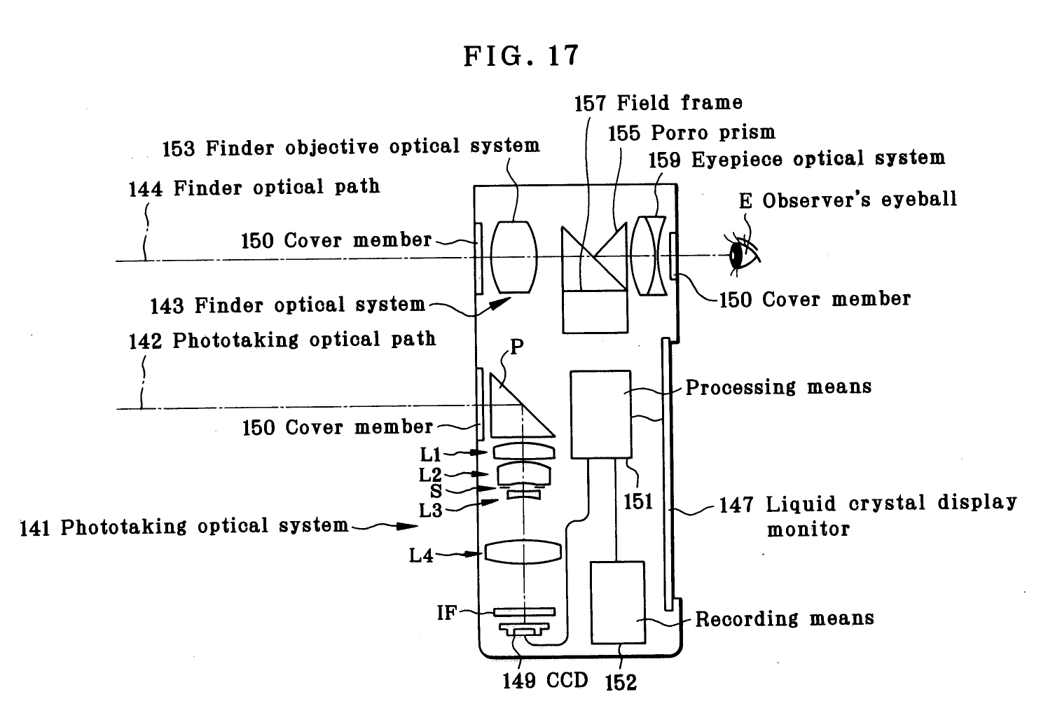

FIGS. 15, 16 and 17 are conceptual illustrations of a phototaking optical system 141 for digital cameras, in which the image-formation lens system of the invention is incorporated. FIG. 15 is a front perspective view of the outside shape of a digital camera 140, and FIG. 16 is a rear perspective view of the same. FIG. 17 is a sectional view of the construction of the digital camera 140. In this embodiment, the digital camera 140 comprises a phototaking optical system 141 including a phototaking optical path 142, a finder optical system 143 including a finder optical path 144, a shutter 145, a flash 146, a liquid crystal monitor 147 and so on. As the shutter 145 mounted on the upper portion of the camera 140 is pressed down, phototaking takes place through the phototaking optical system 141, for instance, a lens system wherein the image-formation lens system according to Example 1 is provided on its object side with an optical path-bending prism P. An object image formed by the phototaking optical system 141 is formed on the image pickup plane of a CCD 149 via a near-infrared cut filter IF. An object image received at CCD 149 is shown as an electronic image on the liquid crystal monitor 147 via processing means 151, which monitor is mounted on the back of the camera. This processing means 151 is connected with recording means 152 in which the phototaken electronic image may be recorded. It is here noted that the recording means 152 may be provided separately from the processing means 151 or, alternatively, it may be constructed in such a way that images are electronically recorded and written therein by means of floppy discs, memory cards, MOs or the like. This camera may also be constructed in the form of a silver-halide camera using a silver-halide film in place of CCD 149.

Moreover, a finder objective optical system 153 is located on the finder optical path 144. An object image formed by the finder objective optical system 153 is in turn formed on the field frame 157 of a Porro prism 155 that is an image-erecting member. In the rear of the Porro prism 155 there is located an eyepiece optical system 159 for guiding an erected image into the eyeball E of an observer. It is here noted that cover members 150 are provided on the entrance sides of the phototaking optical system 141 and finder objective optical system 153 as well as on the exit side of the eyepiece optical system 59.

With the thus constructed digital camera 140, it is possible to achieve high performance and cost reductions, because the phototaking optical system 141 is constructed of an image-formation lens having a wide-angle arrangement with satisfactory aberrations and a back focus large enough to receive a filter, etc. therein.

In the embodiment of FIG. 17, plane-parallel plates are used as the cover members 150; however, it is acceptable to use powered lenses.

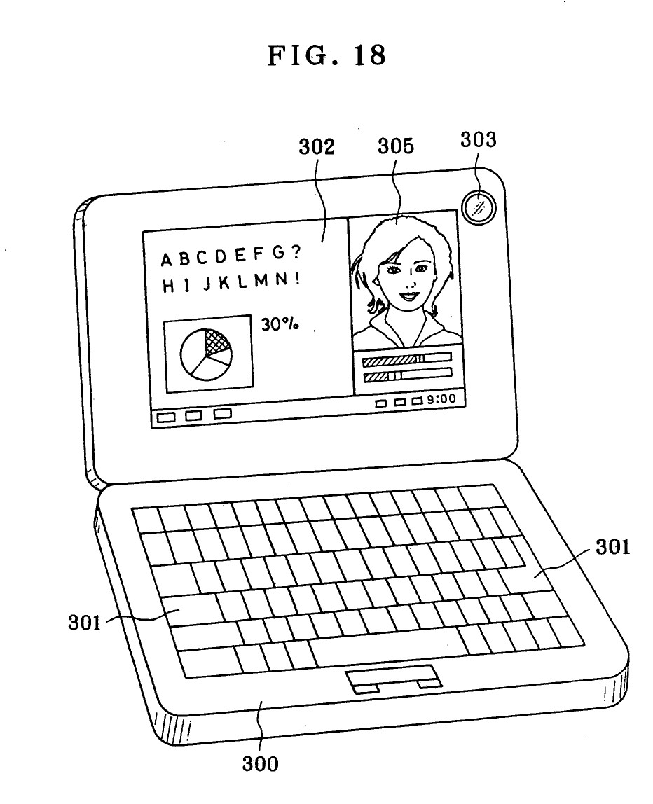

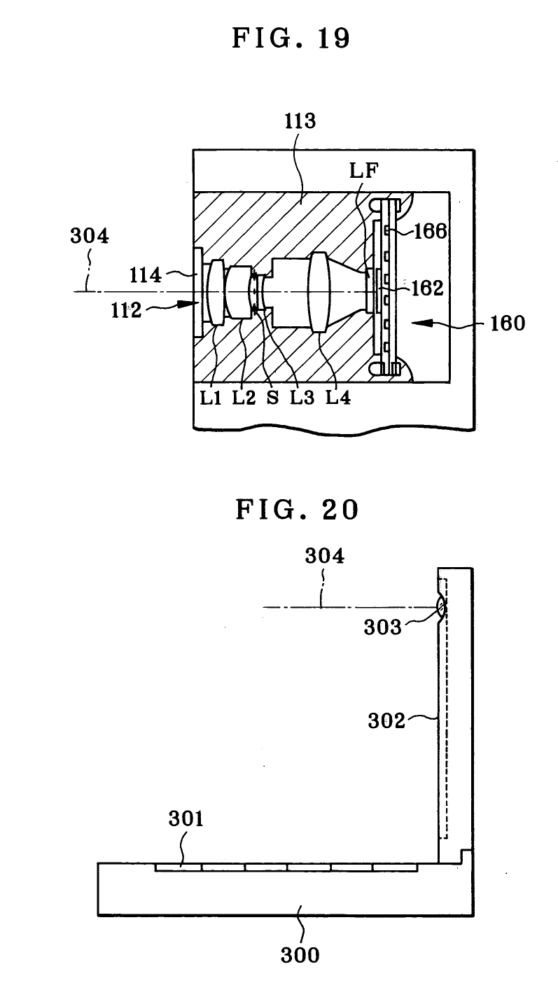

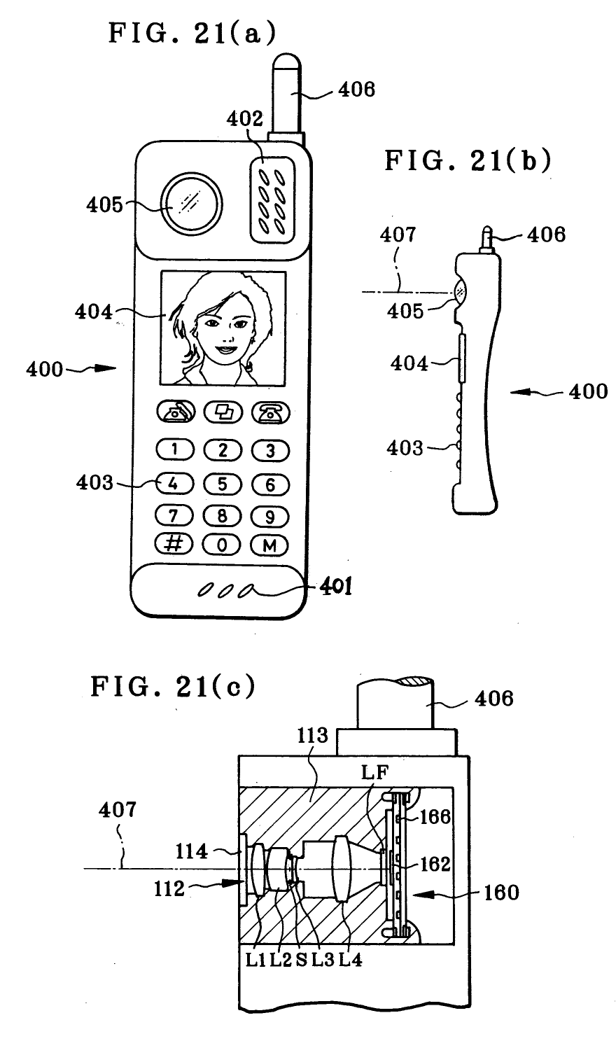

FIGS. 18, 19 and 20 are illustrative of a personal computer that is one example of the information processor in which the image-formation lens system of the invention is built as an objective optical system. FIG. 18 is a front perspective view of a personal computer 300 that is in an uncovered state, FIG. 19 is a sectional view of a phototaking optical system 303 in the personal computer 300, and FIG. 20 is a side view of the state of FIG. 18. As shown in FIGS. 18, 19 and 20, the personal computer 300 comprises a keyboard 301 via which an operator enters information therein from outside, information processing or recording means (not shown), a monitor 302 on which the information is shown for the operator, and a phototaking optical system 303 for taking an image of the operator and surrounding images. For the monitor 302, use could be made of a transmission type liquid crystal display device illuminated by backlight (not shown) from the back surface, a reflection type liquid crystal display device in which light from the front is reflected to show images, or a CRT display device. While the phototaking optical system 303 is shown as being built in the right upper portion of the monitor 302, it may be located somewhere around the monitor 302 or keyboard 301.

This phototaking optical system 303 comprises, on a phototaking optical path 304, an objective lens 112 comprising the image-formation lens system of the invention) and an image pickup device chip 162 for receiving an image. These are built in the personal computer 300.

Here an optical low-pass filter F is additionally applied onto the image pickup device chip 162 to form an integral imaging unit 160, which can be fitted into the rear end of the lens barrel 113 of the objective lens 112 in one-touch operation. Thus, the assembly of the objective lens 112 and image pickup device chip 162 is facilitated because of no need of alignment or control of surface-to-surface spacing. The lens barrel 113 is provided at its end with a cover glass 114 for protection of the objective lens 112. It is here noted that driving mechanisms for the zoom lens, etc. contained in the lens barrel 113 are not shown.

An object image received at the image pickup device chip 162 is entered via a terminal 166 in the processing means of the personal computer 300, and shown as an electronic image on the monitor 302. As an example, an image 305 taken of the operator is shown in FIG. 18. This image 305 may be shown on a personal computer on the other end via suitable processing means and the Internet or telephone line.

FIGS. 21(a), 21(b) and 21(c) are illustrative of a telephone set that is one example of the information processor in which the zoom lens of the invention is built in the form of a phototaking optical system, especially a convenient-to-carry cellular phone. FIG. 21(a) and FIG. 21(b) are a front and a side view of a cellular phone 400, respectively, and FIG. 21(c) is a sectional view of a phototaking optical system 405. As shown in FIGS. 21(a), 21(b) and 21(c), the cellular phone 400 comprises a microphone 401 for entering the voice of an operator therein as information, a speaker 402 for producing the voice of the person on the other end, an input dial 403 via which the operator enters information therein, a monitor 404 for displaying an image taken of the operator or the person on the other end and indicating information such as telephone numbers, a phototaking optical system 405, an antenna 406 for transmitting and receiving communication waves, and processing means (not shown) for processing image information, communication information, input signals, etc. Here the monitor 404 is a liquid crystal display device. It is noted that the components are not necessarily arranged as shown. The phototaking optical system 405 comprises, on a phototaking optical path 407, an objective lens 112 comprising the image-formation lens system of the invention and an image pickup device chip 162 for receiving an object image. These are built in the cellular phone 400.

Here an optical low-pass filter F is additionally applied onto the image pickup device chip 162 to form an integral imaging unit 160, which can be fitted into the rear end of the lens barrel 113 of the objective lens 112 in one-touch operation. Thus, the assembly of the objective lens 112 and image pickup device chip 162 is facilitated because of no need of alignment or control of surface-to-surface spacing. The lens barrel 113 is provided at its end with a cover glass 114 for protection of the objective lens 112. It is here noted that driving mechanisms for the zoom lens, etc. contained in the lens barrel 113 are not shown.

An object image received at the image pickup device chip 162 is entered via a terminal 166 in processing means (not shown), so that the object image can be displayed as an electronic image on the monitor 404 and/or a monitor at the other end. The processing means also include a signal processing function for converting information about the object image received at the image pickup device chip 162 into transmittable signals, thereby sending the image to the person at the other end.

Additionally, the image-formation lens system of the invention could be embodied as follows.

(1) An image-formation lens system, characterized by comprising in order from an object side toward an image side thereof,

a first lens unit comprising a first lens having positive power,

a second lens unit comprising a second lens having positive power,

a third lens unit comprising a third lens having negative power, and

a fourth lens unit comprising a fourth lens having positive power, and satisfying the following conditions (1) to (4):

50<ν_{d1}<110 (1)

1.75<n_{d2}<2.1 (2)

10<ν_{d3}<30 (3)

1.75<n_{d4}<2.1 (4)

where ν_{d1} is the Abbe number on a d-line basis of the first lens, n_{d2} is the d-line refractive index of the second lens, ν_{d3} is the Abbe number on a d-line basis of the third lens, and n_{d4} is the d-line refractive index of the fourth lens.

(2) An image-formation lens system, characterized by comprising, in order from the object side toward the image side thereof, a first lens having positive power, a second lens having positive power, a third lens having negative power, a fourth lens having positive power and an electronic image pickup device located on an image plane, and satisfying the following condition (7) with respect to the reduction ratio of the image-formation lens system comprising the first to fourth lenses:

0.12<|β|<0.60 (7)

(3) An image-formation lens system, characterized by comprising, in order from the object side toward the image side thereof, a first lens having positive power, a second lens having positive power, a third lens having negative power, a fourth lens having positive power and an electronic image pickup device located on an image plane, wherein the reduction ratio of the image-formation lens system comprising the first to fourth lenses satisfies the following condition (7) as well as the following condition (6):

0.12<|β|<0.60 (7)

1.5<f_{F}/f_{R}<4.0 (6)

where f_{F} is the composite focal length of the first to third lenses and f_{R} is the focal length of the fourth lens.

(4) An image-formation lens system, characterized by comprising, in order from the object side toward the image side thereof, a first lens having positive power, a second lens having positive power, a third lens having negative power, a fourth lens having positive power and an electronic image pickup device located on an image plane, and satisfying the following conditions (8) as well as the following condition (5):

7.1°<φ<20° (8)

0.1<D/f<0.6 (9)

where φ is an angle made by an off-axis chief ray passing from the first lens through the fourth lens to form an image at the farthest image end and a normal to the image pickup plane of the electronic image pickup device, D is the axial space between the third lens and the fourth lens, and f is the focal length of the image-formation lens system.

(5) An image-formation lens system, characterized by comprising, in order from the object side toward the image side thereof, a first lens having positive power, a second lens having positive power, a third lens having negative power, a fourth lens having positive power and an electronic image pickup device located on an image plane, wherein between the first lens and an object or between the fourth lens and the image plane there is located an optical element for bending an optical path.

(6) The image-formation lens system according to any one of (1) to (5) above, characterized in that a stop is located in an optical path between the second lens and the fourth lens.

(7) The image-formation lens system according to any one of (2) to (5) above, characterized in that the first lens is constructed in such a way as to satisfy the following condition (1):

50<ν_{d1}<110 (1)

where ν_{d1} is the Abbe number on a d-line basis of the first lens.

(8) The image-formation lens system according to any one of (2) to (5) above, characterized in that the second lens is constructed in such a way as to satisfy the following condition (2):

1.75<n_{d2}<2.1 (2)

where n_{d2} is the d-line refractive index of the second lens.

(9) The image-formation lens system according to any one of (2) to (5) above, characterized in that the third lens is constructed in such a way as to satisfy the following condition (3):

10<ν_{d3}<30 (3)

where ν_{d3} is the Abbe number on a d-line basis of the third lens.

(10) The image-formation lens system according to any one of (2) to (5) above, characterized in that the fourth lens is constructed in such a way as to satisfy the following condition (4):

1.75<n_{d4}<2.1 (4)

where n_{d4} is the d-line refractive index of the fourth lens.

(11) The image-formation lens system according to (1), (2), (3) or (5) above, characterized in that the third lens and the fourth lens are constructed in such a way as to satisfy the following condition (5):

0.1<D/f<0.6 (5)

where D is the axial space between the third lens and the fourth lens, and f is the focal length of the image-formation lens system.

(12) The image-formation lens system according to (1), (2), (4) or (5) above, characterized in that the first to fourth lenses are constructed in such a way as to satisfy the following condition (6):

1.5<f_{F}/f_{R}<4.0 (6)

where f_{F} is the composite focal length of the first to third lenses, and f_{R} is the focal length of the fourth lens.

(13) The image-formation lens system according to (1), (4) or (5) above, characterized in that the first to fourth lenses are constructed in such a way as to satisfy the following condition (7):

0.12<|β|<0.60 (7)

where β is the reduction ratio of the image-formation lens system comprising the first to fourth lenses.

(14) The image-formation lens system according to (1), (2), (3) or (5) above, characterized by satisfying the following condition (8):

7.1°<φ<° (8)

where φ is an angle made by an off-axis chief ray passing from the first lens through the fourth lens to form an image at the farthest image end and a normal to the image pickup plane of the electronic image pickup device.

(15) The image-formation lens system according to any one of (1) to (14) above, characterized in that the first lens comprises one positive lens.

(16) The image-formation lens system according to any one of (1) to (15) above, characterized in that the second lens comprises one positive lens.

(17) The image-formation lens system according to any one of (1) to (16) above, characterized in that the third lens comprises one negative lens.

(18) The image-formation lens system according to any one of (1) to (13) above, characterized in that the fourth lens comprises one positive lens.

(19) An image-formation lens system, characterized by at least comprising:

a stop,

a positive lens unit located in front of the stop and having generally positive power,

a positive lens unit located in rear of the stop and having negative power,

a positive lens unit located between the negative lens unit and the image side of the image-formation lens system, and having positive power, and

an electronic image pickup device located on an image plane formed by the image-formation lens system, wherein the electronic image pickup device is a color line sensor comprising an array of photoreceptors provided thereon with at least red (R), green (G) and blue (B) color filters, and an image light beam formed by the image-formation lens system on the electronic image pickup device satisfies the following conditions (7) and (8):

0.12<|β|<0.60 (7)

7.1°<φ<20° (8)

where β is the reduction ratio of the image-formation lens system, and φ is an angle made by an off-axis chief ray passing through the image-formation lens system to form an image at the farthest image end and a normal to the image plane of the electronic image pickup device.

(20) The image-formation lens system according to (19) above, characterized in that the object position of the image-formation lens system remains fixed, and is spaced at most 200 mm away from the image plane formed by the image-formation lens system.

(21) The image-formation lens system according to any one of (1) to (20) above, characterized in that both surfaces of at least one lens are defined by convex or concave surfaces having an equal radius of curvature.

(22) An imaging system, characterized in that an image-formation optical system as recited in any one of (1) to (21) above is located as an imaging optical system.

(23) An ink jet recorder system, characterized by comprising a carriage that reciprocates along an opposing recording medium, wherein:

the carriage comprises:

an ink jet unit mounted on the carriage and comprising a plurality of ink jet nozzles that jet ink onto the opposite recording medium during movement of the carriage to form an image on the opposing recording medium,

image reading means mounted on the carriage for providing an optical reading of the image formed on the opposite recording medium during movement of the carriage, and

lighting means mounted on the carriage for lighting a range of allowing the image reading means to read the image on the opposite recording means, wherein:

the image reading means incorporates an image-formation lens system as recited in any one of (1) to (21) above.

(24) The ink jet recorder system according to (23) above, characterized in that the point of light emission of the lighting means is displaced from the optical axis of the image reading means, and the lighting means is located on the carriage while the optical axis of the lighting means is inclined with respect to the optical axis of the image reading means such that the center of an area illuminated by the light means with respect to the opposite recording medium is in alignment with the optical axis of the image reading means.

(25) The ink jet recorder system according to (23) or (24) above, characterized in that the lighting means includes a light-emitting device.

(26) The ink jet recorder system according to any one of (23) to (25) above, characterized in that the image reading means includes an electronic image pickup device.

(27) The ink jet recorder system according to any one of (23) to (26) above, characterized in that the electronic image pickup device is a line sensor.

(28) The image-formation lens system, imaging system, and ink jet recorder system according to any one of (1) to (27) above, characterized in that the object plane and the image plane are reversed in position in such a way as to provide a magnifying optical system.

As can be appreciated from what has been described, the present invention can provide an image-formation lens system for reading images, which, albeit having a magnification of less than 1×, can be composed of a limited number of lenses with a short length and compactness at lower cost, and ensures much better image quality.

What we claim is:

1. An image-formation lens system, comprising in order from an object side toward an image side thereof,
a first lens unit having positive power,
a second lens unit having positive power,
a third lens unit having negative power, and
a fourth lens unit having positive power, and satisfying the following conditions (1) to (4):
50<ν_{d1}<110 (1)
1.75<n_{d2}<2.1 (2)
10<ν_{d3}<30 (3)
1.75<n_{d4}<2.1 (4)
where ν_{d1} is an Abbe number on a d-line basis of the first lens unit, n_{d2} is a d-line refractive index of the second lens unit, 84 _{d3} is an Abbe number on a d-line basis of the third lens unit, and n_{d4} is a d-line refractive index of the fourth lens unit.

2. An image-formation lens system, comprising in order from an object side toward an image side thereof,
a first lens unit having positive power,
a second lens unit having positive power,
a third lens unit having negative power, and
a fourth lens unit having positive power, and satisfying the following condition (7):
0.12<|β|<0.60 (7)
where β is a magnification of the image-formation lens system.

3. An image-formation lens system, comprising in order from an object side toward an image side thereof,
a first lens unit having positive power,
a second lens unit having positive power,
a third lens unit having negative power, and
a fourth lens unit having positive power, and satisfying the following conditions (6) and (7):
1.5<f_{F}/f_{R}<4.0 (6)
0.12<|β|<0.60 (7)
where f_{F} is a composite focal length of the first to third lens units, f_{R} is a focal length of the fourth lens unit, and β is a magnification of the image-formation lens system.

4. An image-formation lens system, comprising in order from an object side toward an image side thereof,
a first lens unit having positive power,
a second lens unit having positive power,
a third lens unit having negative power, and
a fourth lens unit having positive power, and satisfying the following conditions (5) and (8):
0.1<D/f<0.6 (7)
7.1°<φ<20° (8)
where D is an axial space between the third lens unit and the fourth lens unit, f is a focal length of the image-formation lens system, and φ is an angle made by two light rays at a position of an image formed by the image-formation lens system, wherein one of the two light rays is an off-axis chief ray passing through a position of a maximum image height and another is parallel with an optical axis of the image-formation lens system.

5. An image-formation lens system, comprising in order from an object side toward an image side thereof,
a first lens unit having positive power,
a second lens unit having positive power,
a third lens unit having negative power,
a fourth lens unit having positive power, and an optical element for bending an optical path, located between the first lens unit and the object or between the fourth lens unit and the image.

6. The image-formation lens system according to claim 1, which further comprises an aperture stop located in an optical path between the second lens unit and the fourth lens unit.

7. The image-formation lens system according to claim 1, wherein the first lens unit comprises one positive lens.

8. The image-formation lens system according to claim 1, wherein the second lens unit comprises one positive lens.

9. The image-formation lens system according to claim 1, wherein the third lens unit comprises one negative lens.

10. The image-formation lens system according to claim 1, wherein the fourth lens unit comprises one positive lens.

11. An image-formation lens system, comprising:
an aperture stop,
a lens unit located in front of the aperture stop and having generally positive power,
a lens unit located in rear of the aperture stop and having generally negative power,
a lens unit located in rear of the lens unit having negative power and having generally positive power, and
an electronic image pickup device located at a position of an image formed by the image-formation lens system, wherein:
the electronic image pickup device is a color line sensor comprising an array of photoreceptors provided thereon with at least red (R), green (G) and blue (B) color filters in association therewith, and the image-formation lens system satisfies the following conditions (7) and (8):
0.12<|β|<0.60 (7)
7.1°<φ<20° (8)
where β is a magnification of the image-formation lens system, and φ is an angle made by two light rays at a position of an image formed by the image-formation lens system, wherein one of the two light rays is an off-axis chief ray passing through a position of a maximum image height and another is parallel with an optical axis of the image-formation lens system.

12. The image-formation lens system according to claim 11, wherein:
the image-formation lens system is provided to form an image of an object at a given distance, and
there is a distance of 200 mm or less up to the image formed by the image-formation lens system.

13. The image-formation lens system according to claim 1 or 11, wherein:
both surfaces of at least one lens are defined by convex or concave surfaces having an equal radius of curvature.

14. An imaging system, comprising an image-formation lens system as recited in claim 1 or 11.

15. An ink jet recorder system, comprising:
a carriage that reciprocates along an opposing recording medium, wherein:
the carriage comprises in combination:
an ink jet unit comprising a plurality of ink jet nozzles that jet ink to form an image on the opposing recording medium,
an image reader unit that optically reads the image formed on the opposing recording medium during movement of the carriage,
a lighting unit for lighting a range in which the image is read by the image reader unit, and
an image-formation lens system as recited in claim 1 or 11, which is mounted on the image reader unit.

16. The ink jet recorder system according to claim 15, wherein:
the lighting unit is located on the carriage in such a way as to satisfy the following conditions:
the thus located lighting unit has a point of light emission in misalignment with an optical axis of the image reader unit, and
a center of a light area illuminated by the lighting unit on the recording medium is in alignment with an optical axis of the image reader unit.

17. The ink jet recorder system according to claim 15, wherein the lighting unit includes a light-emitting device.

18. The ink jet recorder system according to claim 15, wherein the image reader unit includes an electronic image pickup device.

19. The ink jet recorder system according to claim 15, wherein the electronic image pickup device is a line sensor.
